(19) United States
(12) Patent Application Publication
(10) Pub. No.: US 2012/0017550 A1
(43) Pub. Date: Jan. 26, 2012

(54) Horse Rug and Safety Closure for Horse Rugs

(76) Inventor: Veronique Cammas, Kiel (DE)

(21) Appl. No.: 13/258,927

(22) PCT Filed: Feb. 1, 2010
(86) PCT No.: PCT/DE10/00098

§ 371 Date: Sep. 22, 2011

(30) Foreign Application Priority Data
Mar. 27, 2009 (DE) 20 2009 004 105.0

(51) Int. Cl. B68C 5/00

(52) U.S. Cl. 54/79.2

(57) ABSTRACT

A horse rug comprising at least one closure, wherein the closure is made of a first closure element fastened to the horse rug at a first position, a second closure element fastened to the horse rug at a second position, and a third closure element connecting the first closure element to the second closure element, wherein the third closure element has a lower tear resistance than the first and second closure elements.

The invention relates to a horse rug and a safety closure for a horse rug equipped with a closure that is made of a first closure element and a second closure element, the materials forming the closure having a predetermined tear resistance.

Horse rugs are used to protect horses from various types of influences, for example climatic influences. According to their intended purpose, a distinction is made between winter and thermal rugs, sweat rugs, rain and riding rugs, reflecting rugs and summer and anti-fly rugs. According to their intended purpose, the different rugs are manufactured from different materials so that the intended use can be achieved effectively.

All horse rugs have in common that on the one hand they lie loosely on the horses, but on the other hand are also to be fastened to them firmly. Therefore the horse rugs exhibit closures that are fastened to the horse rug by means of loops or straps. These closures are for example T-closures, snap hooks or hunting quick-release fittings, preferably made from metal, or catches that are preferably made from plastic and consist of a plug and a jack receiving the plug.

So fastening of the horse rugs to the horses can be guaranteed in a way that is as safe and permanent as possible, the materials that form the closures exhibit a known tear resistance (tensile strength). The tear resistance is adjusted such that the closures hold together those sections of the horse rug even under load that are interconnected by the closures. If, however, a certain value is exceeded, the horse rug closure will tear—this is desirable in particular in hazardous situations where else the horse could sustain serious injuries.

However situations have often arisen where the closure of a horse rug did not yield to the high loading and the horses sustained heavy injuries by the closure or the straps carrying the closure.

In addition, a disadvantage of the known closures for horse rugs is that when the horse rug closure tears, the closure that is preferably made from metal or preferably made from plastic, the loops or straps of the horse rug that carry the closure or the area where in turn the loops or straps are fastened to the horse rug are strongly damaged to such an extent that the horse rug can no longer be used or only with a high degree of repair effort. However, the horse rugs that have been repaired by sewing have an appearance that is not very attractive aesthetically and is less reliable in terms of fastening the horse rug to the horse.

The object of the invention is therefore to provide a horse rug that avoids the risk of injuries for horses when the horses become entangled in the closures, in particular the abdominal belts, and that at the same time is difficult to damage. In addition, it is the object of the invention to provide a closure for horse rugs that reduces the risk that the closure injures the horses.

The object is achieved by the horse rug having the features of Claim 1 and by the safety closure having the features of Claim 10. The subclaims each represent advantageous embodiments of the invention.

The basic idea of the invention is to interconnect closures present on horse rugs by means of a further safety closure, the safety closure having a lower tear resistance than the materials forming the closure, of the horse rug or the horse rug itself. This on the one hand ensures that the horse rug opens in hazardous situations, for example when exceeding a predefined load, and can come off the horseback, and on the other hand that it is not the horse rug itself that is damaged, in particular the closure of the horse rug. Therefore the integrity of the horse rug is maintained, and it can be reused again immediately without complex repair measures, in that simply a new safety closure is fastened to the horse rug whose costs only amount to a small fraction of the costs of a horse rug or repairing a horse rug.

The invention is explained in more detail using an exemplary embodiment that is illustrated in the drawings and is of particularly preferable design. In the drawings:

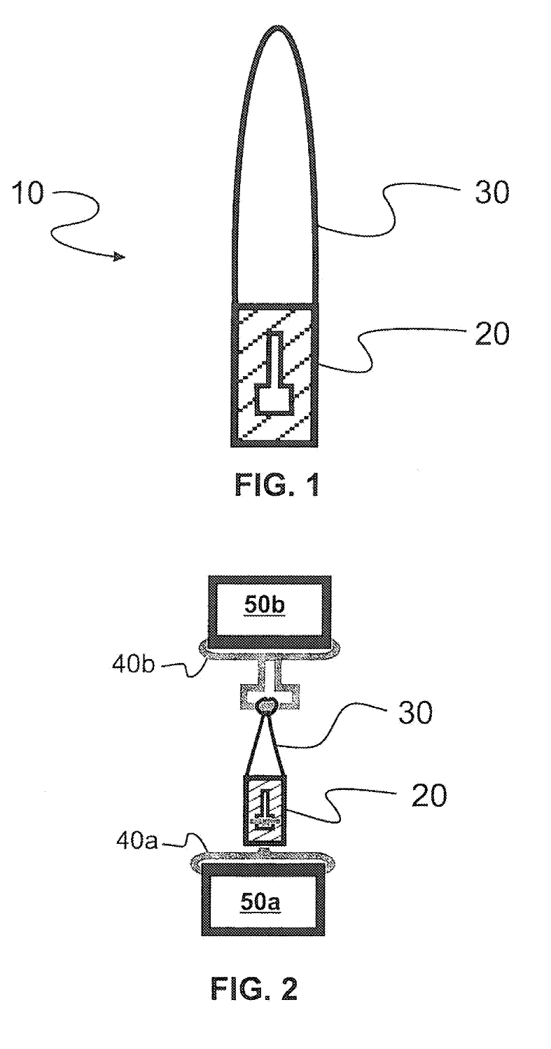

FIG. 1 shows a schematic view of a safety closure according to the invention that is of particularly preferred design;

FIG. 2 shows a schematic view of the safety closure from FIG. 1 that is fastened to a horse rug;

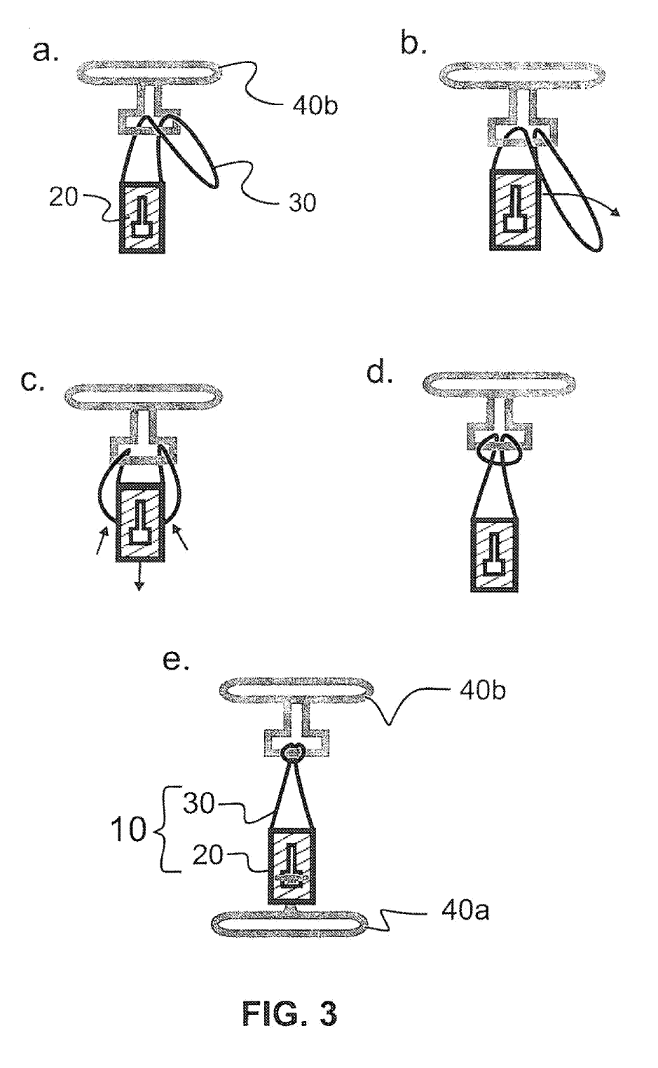

FIG. 3 shows a schematic work instruction for fastening the safety closure to the closure of a horse rug;

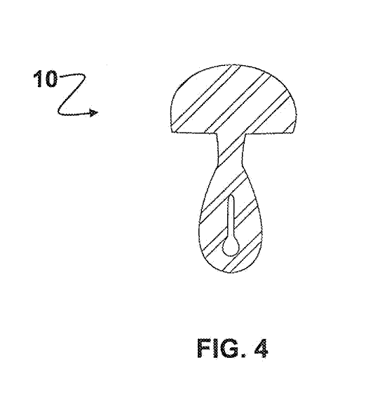

FIG. 4 shows a particularly designed safety closure for retrofitting horse rugs with T-closures;

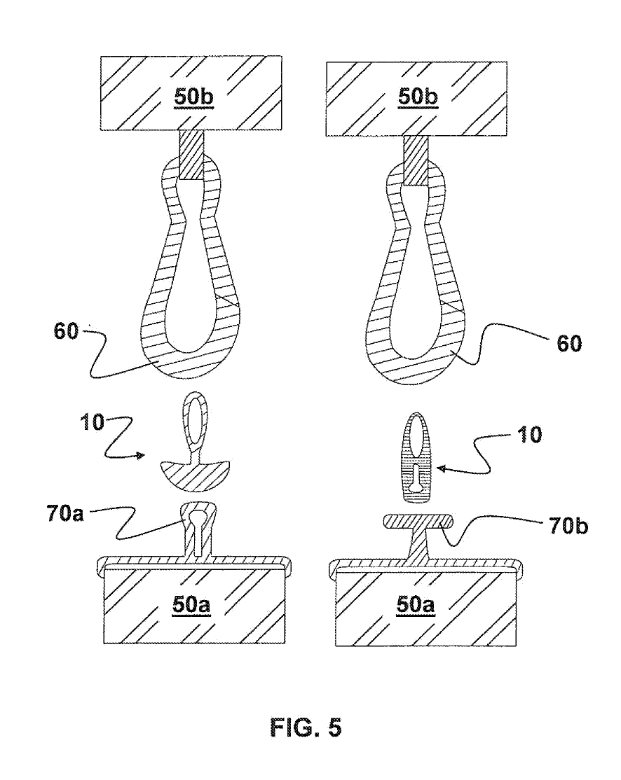

FIG. 5 shows a horse rug with preferably designed examples of the inventive safety closure with incompatible closure elements that are fastened to the horse rug; and

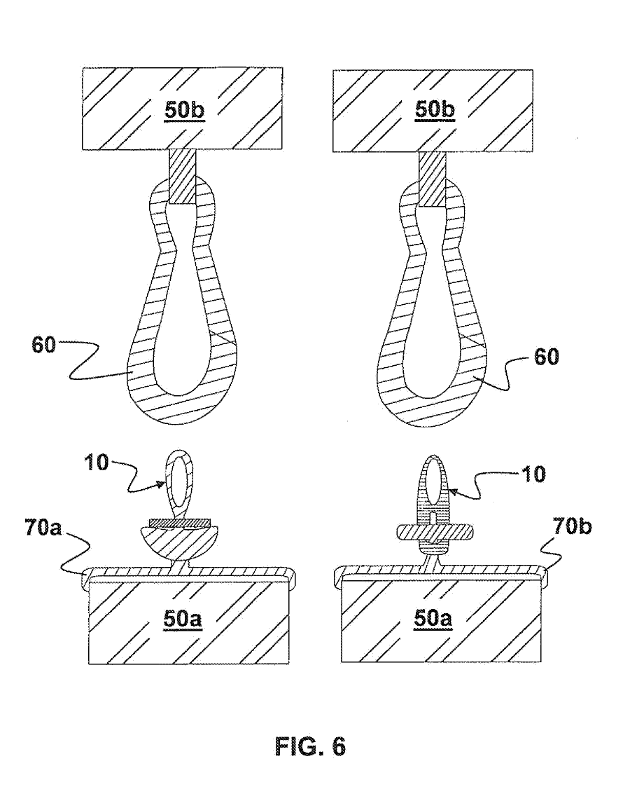

FIG. 6 shows the safety closures shown in FIG. 5 that are fastened to a closure element of the horse rug.

FIG. 1 shows the safety closure according to the invention in a schematic illustration. The safety closure 10 preferably consists of a first section 20 that has a recess for receiving the one part of the closure of the horse rug, and a second section 30 that has a loop-shaped design and is designed for fastening to the other part of the closure of the horse rug.

To better understand the invention, FIG. 2 shows a schematic illustration of the safety closure 10 that is fastened to a closure of a horse rug. The closure of the horse rug, that is illustrated as a T-closure in the example, consists of two interconnectable parts 40a, 40b, 50a, 50b. Here the one part 40a, 50a of the closure is formed by a first locking element 40a that is preferably made from metal, and a fastening element 50a that fastens the locking element 40a to the horse rug and that can be a strap or a loop. The other part 40b, 50b of the closure is of a corresponding design, the other locking element 40b forming a lock with the first locking element 40a.

Fastening the safety closure 10 takes place on a closure 40a, 40b, 50a, 50b, designed as a T-closure, of a horse rug, as can be guessed from FIG. 2, preferably according to the steps shown in FIG. 3. Initially the loop-shaped section 30 of the safety closure 10 is pulled through the receptacle of the locking element 40b, that usually receives the T-piece, of the closure (FIG. 3a), and then the first section 20 of the safety closure 10 is pulled through the loop of the second section 30 (FIG. 3b, 3c) and tied down (FIG. 3d).

The horse rug can now be closed and fastened to the horse in that the T-piece 40a of the closure of the horse rug is hooked into the closure 40b that is not fastened directly to the horse rug, but into the recess of the first section 20 of the inventive safety closure 10.

If a great force is exerted on the closure 40a, 40b, 50a, 50b of the horse rug and the safety closure 10, according to the invention the safety closure 10 will tear, but not the closure 40a, 40b, 50a, 50b of the horse rug, since the tear resistance of the safety closure 10 is lower than the tear resistance of the materials forming the closure 40a, 40b, 50a, 50b of the horse rug. This ensures that the horse remains uninjured and the horse rug undamaged—the horse rug can simply be fitted with a new safety closure 10 and reused.

According to a preferred embodiment of the invention it is provided that the tear resistance of the second section 30 of the safety closure is lower than the tear resistance of the first section 20. This ensures that the one part of the closure 40a of the horse rug is always safely connected to the receptacle of the first section 20 of the safety closure 10.

In addition, the second section 20 preferably has a predetermined breaking point.

A particularly simple design of the invention is obtained in that the second section 30 is of ring-shaped design and the first section 20 is preferably designed as a tag that partly surrounds the second section 30. This achieves the situation that only the second section 30 needs replacing in the case of a defect of the safety closure 10.

According to a further preferred design, the recess in the first section 20 of the safety closure 10 for receiving the T-piece 40a of a T-closure consists of an approximately square region and a region that extends from there like a slot.

However, the first section 20 can also be designed as a hook, for example a snap hook.

As an alternative to this, the first section 20 can exhibit a catch receptacle for a catch plug so that also catches can be interconnected. It is particularly preferred that in this case the second section 30 exhibits a snap-closure plug that can be inserted into the catch receptacle of the closure that is fastened to the horse rug.

Like the safety closures 10 shown in FIG. 1 to FIG. 3, the safety closure 10 that is shown in FIG. 4 and is of particular design can also be used for retrofitting horse rugs. This safety closure 10 exhibits a shape like pillar fungi, the hat-shaped section of the safety closure 10 being introduced into the eyelet of the T-closure and fixated and the T-piece of the T-closure being inserted into an opening introduced in the stick-shaped section of the safety closure 10. The opening is preferably of slot-shaped design, the slot having a long section of lesser width that approximately corresponds to the thickness of a T-piece, and a short wide section whose width approximately corresponds to the width of the piece at its smallest width. A slot of such design enables the T-piece to be inserted and positioned in a simple manner without any risk that the piece slides out of the safety closure 10.

FIG. 5 shows a horse rug of particularly preferred design having two particularly designed safety closures 10. In the upper part of the picture, the horse rug shows a first closure element 60 that is fastened to a strap 50b that is for example sewn to the horse rug. In the lower part of the picture a second closure element 70a that is fastened to a further strap 50a sewn to the horse rug is provided. The first closure element 60 is designed as a snap hook 60 in the example shown. The second closure element 70a is for example designed as an eyelet 70a for receiving a T-piece or as a T-piece 70b of a T-closure.

As can be recognised easily, the first closure element 60 and the second closure element 70a, 70b are mutually incompatible, i.e. the first closure element 60 and the second closure element 70a, 70b cannot be interconnected for fastening the rug on the horse. A horse rug of such design prevents the horse owner from closing the horse rug with the two closure elements 60, 70a, 70b.

Closing the horse rug is not effected until the third closure element 10 that exhibits a first section that can be connected to the first closure element 60, and a second section that can be connected to the second closure element 70a, 70b. The third closure element 10 here acts as a predetermined breaking point in case forces of such magnitude arise at the closure that can damage the horse rug or the closure elements 60, 70a, 70b fastened thereto. To this end, the one section of the third closure element 10 can exhibit—as mentioned earlier—a lower tear resistance than the other section of the third closure element 10.

In each section, the third closure element 10 can exhibit—as shown to the right in FIG. 5 and FIG. 6—a receptacle each for receiving the first and the second closure element 60, 70b or can be of anchor-shaped design, the sickle-shaped structure of the eyelet of the second closure element 70a and the loop-shaped section being received by the snap hook 60 (see FIG. 6).

On the one hand, injuries of the horse are prevented with this inventive design of a horse rug, on the other hand it is ensured that the horse rug cannot be damaged by improper usage. Usage of the horse rug can therefore only take place by using the third closure element 10 that can make a connection on the one hand with the first closure element 60 and on the other hand with the second closure element 70a, 70b. If a load that acts on the closure 50b, 60, 10, 70a/70b, 50a should be of such a magnitude that there is a risk of the horse being injured or the materials of the horse rug being strained excessively, the third closure element 10 will tear—as shown above—and the closure will be opened. When the inventive horse rug is used properly, there is therefore no risk of the horse being injured or the horse rug being damaged.

FIG. 6 shows the safety closures known from FIG. 5 that are fastened at the T-piece that is shown below and fastened to the horse rug and only have to be inserted into the snap hook that is shown above and fastened to the horse rug, so as to close the horse rug and to fasten it safely on the horse.

Here the shape of the closure elements 60, 70a/70b fastened to the horse rug is of no importance—care only has to be taken that the closure elements 60, 70a/70b cannot be connected to each other, that is to say they are mutually incompatible. Closing the horse rug takes place by means of the third closure element 10 that exhibits a first section that can be connected to the first closure element 60, and a second section that can be connected to the second closure element 70a, 70b. In the simplest case, the third closure element 10 can be designed as an annular, preferably elastic (rubber) band having a known tear resistance that is fastened for example as shown in FIG. 3 to the eyelet of a T-closure, the band being sized such that the remaining loop can be placed around the T-piece of the T-closure and fixated without the section 30 having to be of a particular design.

In summary, the first and the second closure elements 60, 70a, 70b are mutually incompatible, but the third closure element 10 is on the one hand compatible to the first closure element 60 and on the other hand to the second closure element 70a, 70b. In a particularly preferred manner, the interconnectable closure elements can also have a mutually complementary design such that they exert a key-lock-function.

The health of the horses can thus be ensured using the inventive closure and in particular the horse rug of inventive design, also the material of the horse rug being treated with care and possibly the dealers being prompted to provide a guarantee for the service life of the horse rug.

1. A horse rug having at least one closure, the closure being made
of a first closure element fastened to the horse rug in a first position,
a second closure element fastened to the horse rug in a second position, and
a third closure element connecting the first closure element to the second closure element,
the third closure element having a lower tear resistance than the first and second closure elements.

2. The horse rug according to claim 1, characterised in that the first closure element is incompatible with the second closure element.

3. The horse rug according to claim 1, characterised in that the third closure element exhibits a first section that can be connected to the first closure element and a second section that can be connected to the second closure element.

4. The horse rug according to claim 3, characterised in that the first section is of complementary design to the first closure element and the second section is of complementary design to the second closure element.

5. The horse rug according to claim 1, characterised in that the first and the second closure element are of mutually compatible design and the third closure element exhibits a first section that is of complementary design to the first closure element and a second section that is of complementary design to the second closure element.

6. The horse rug according to claim 5, characterised in that the first and the second closure element form a T-closure.

7. The horse rug according to claim 1, characterised in that the third closure element has a predetermined breaking point.

8. The horse rug according to claim 1, characterised in that the third closure element is designed as a predetermined breaking point.

9. The horse rug according to claim 1, characterised in that the tear resistance of the one section of the third closure element is less than the tear resistance of the other section of the third closure element.

10. A safety closure for a horse rug that is fitted with a closure that is formed from a first closure element and a second closure element, the materials forming the closure having a known tear resistance,
characterised in that
the safety closure is connectable to the first closure element and the second closure element, the safety closure exhibiting a tear resistance that is lower than the tear resistance of the materials, that form the closure, of the horse rug.

11. The safety closure according to claim 10, characterised by a first section that exhibits a recess for receiving the first closure element and a second section of loop-shaped design for fastening on the second closure element.

12. The safety closure according to claim 10, characterised in that the tear resistance of the second section is lower than the tear resistance of the first section.

13. The safety closure according to claim 10, characterised in that the second section exhibits a predetermined breaking point.

14. The safety closure according to claim 10, characterised in that the second section is of annular design.

15. The safety closure according to claim 10, characterised in that the first section is designed as a tag that partly surrounds the second section.

16. The safety closure according to claim 10, characterised in that the recess consists of an area of rectangular design and an area that extends from there in the shape of a slot.

17. The safety closure according to claim 10, characterised in that the first section is designed as a hook.

18. The safety closure according to claim 10, characterised in that the first section exhibits a snap-closure receptacle.

19. The safety closure according to claim 18, characterised in that the second section exhibits a snap-closure plug.
